(19) United States
(12) Patent Application Publication
(10) Pub. No.: US 2011/0281468 A1
(43) Pub. Date: Nov. 17, 2011

(54) ELECTRICAL CONNECTOR WITH IMPROVED CONTACT STRUCTURE FOR HIGH FREQUENCY SIGNAL TRANSMISSION

(75) Inventors: Wang-I YU, JHONGHE (TW); Hung-Chi TAI, JHONGHE (TW); Yong Gang ZHANG, TAICANG (CN)

(73) Assignee: ALLTOP ELECTRONICS (SUZHOU) CO., LTD, Taicang City (CN)

(21) Appl. No.: 12/913,164

(22) Filed: Oct. 27, 2010

(30) Foreign Application Priority Data
May 14, 2010 (CN) 201010172453.4

(51) Int. Cl. H01R 24/00

(52) U.S. Cl. 439/660

(57) ABSTRACT

An electrical connector includes an insulative housing, a first set of contacts insert-molded with the insulative housing and a second set of contacts assembled to the insulative housing. The first set of contacts includes at least one pair of differential contacts for transmitting high-speed signals. Each first contact includes a nonelastic first mating portion, a first retention portion parallel to the first mating portion, a first tail portion extending from the first retention portion and extending beyond the insulative housing, and a connecting portion connecting the first mating portion and the first retention portion with a width narrower than that of the first mating portion and the first retention portion.

### BACKGROUND OF THE INVENTION

1. Field of the Invention

The present invention relates to an electrical connector, more particularly to an electrical connector compatible to standard Universal Serial Bus (USB) 2.0 connector.

2. Description of Related Art

Recently, personal computers (PC) are used of a variety of techniques for providing input and output. Universal Serial Bus (USB) is a serial bus standard to the PC architecture with a focus on computer telephony interface, consumer and productivity applications. The design of USB is standardized by the USB Implementers Forum (USB-IF), an industry standard body incorporating leading companies from the computer and electronic industries. USB can connect peripherals such as mouse devices, keyboards, PDAs, gamepads and joysticks, scanners, digital cameras, printers, external storage, networking components, etc. For many devices such as scanners and digital cameras, USB has become the standard connection method.

As of 2006, the USB specification was at version 2.0 (with revisions). The USB 2.0 specification was released in April 2000 and was standardized by the USB-IF at the end of 2001. Previous notable releases of the specification were 0.9, 1.0, and 1.1. Equipment conforming to any version of the standard will also work with devices designed to any previous specification (known as: backward compatibility).

USB supports three data rates: 1) A Low Speed rate of up to 1.5 Mbit/s (187.5 KB/s) that is mostly used for Human Interface Devices (HID) such as keyboards, mice, and joysticks; 2) A Full Speed rate of up to 12 Mbit/s (1.5 MB/s). Full Speed was the fastest rate before the USB 2.0 specification and many devices fall back to Full Speed. Full Speed devices divide the USB bandwidth between them in a first-come first-served basis and it is not uncommon to run out of bandwidth with several isochronous devices. All USB Hubs support Full Speed; 3) A Hi-Speed rate of up to 480 Mbit/s (60 MB/s). Though Hi-Speed devices are commonly referred to as “USB 2.0” and advertised as “up to 480 Mbit/s”, not all USB 2.0 devices are Hi-Speed. Hi-Speed devices typically only operate at half of the full theoretical (60 MB/s) data throughput rate. Most Hi-Speed USB devices typically operate at much slower speeds, often about 3 MB/s overall, sometimes up to 10-20 MB/s. A data transmission rate at 20 MB/s is sufficient for some but not all applications. However, under a circumstance transmitting an audio or video file, which is always up to hundreds MB, even to 1 or 2 GB, currently transmission rate of USB is not sufficient. As a consequence, faster serial-bus interfaces are being introduced to address different requirements. PCI Express, at 2.5 GB/s, and SATA, at 1.5 GB/s and 3.0 GB/s, are two examples of High-Speed serial bus interfaces.

From an electrical standpoint, the higher data transfer rates of the non-USB protocols discussed above are highly desirable for certain applications. However, these non-USB protocols are not used as broadly as USB protocols. Many portable devices are equipped with USB connectors other than these non-USB connectors. One important reason is that these non-USB connectors contain a greater number of signal pins than an existing USB connector and are physically larger as well. For example, while the PCI Express is useful for its higher possible data rates, a 26-pin connectors and wider card-like form factor limit the use of Express Cards. For another example, SATA uses two connectors, one 7-pin connector for signals and another 15-pin connector for power. Due to its clumsiness, SATA is more useful for internal storage expansion than for external peripherals.

The existing USB connectors have a small size but low transmission rate, while other non-USB connectors (PCI Express, SATA, et al) have a high transmission rate but large size. Neither of them is desirable to implement modern high-speed, miniaturized electronic devices and peripherals. To provide a kind of connector with a small size and a high transmission rate for portability and high data transmitting efficiency is much desirable. In 2007, led by Intel, a technology named USB 3.0 is developed by Intel, HP, NEC, NXP semiconductor, and TI etc which realize rapid, instant signal transmission.

USB 3.0 is compatible with USB 2.0 very well and adds another set of contacts for high-speed signal transmission based on USB 2.0. The added set of contacts comprises two pairs of differential contacts and a grounding contact located between the two pairs of differential contacts for suppressing cross-talk when high-speed signal transmission. The problem existed at present is the added set of contacts is for high-speed, high-frequency signal transmission. In such situation, cross-talk and impedance has much influence to the high-speed, high-frequency signal transmission. Hence, how to decrease the influence of the cross-talk and impedance to the high-speed signal transmission is a direction for related skilled persons.

### BRIEF SUMMARY OF THE INVENTION

accordingly, an object of the present invention is to provide an electrical connector for high-speed, high-frequency signal transmission.

In order to achieve the above-mentioned object, an electrical connector in accordance with the present invention comprises an insulative housing, a first set of contacts insert-molded with the insulative housing, and a second set of contacts assembled to the insulative housing. The insulative housing comprises a rear base portion and a front tongue portion extending from the base portion. The tongue portion defines opposite first supporting surface and second supporting surface both parallel to the mating direction, a plurality of front first contact-receiving passages to communicate with at least one of the first and second supporting surfaces, and a plurality of rear second contact-receiving passages to communicate with at least one of the first and second supporting surfaces. The first set of contacts comprises at least one pair of differential contacts for transmitting high-speed signals. Each first contact comprises a nonelastic first mating portion received in corresponding first contact-receiving passage, a first retention portion interferentially received in the base portion of the insulative housing and located in a surface different from that of the first mating portion, a first tail portion extending from the first retention portion and extending beyond the base portion, and a connecting portion connecting the first mating portion and the first retention portion with a width narrower than that of the first mating portion and the first retention portion. Each of the second set of contacts comprises an elastic second mating portion received in the rear second contact-receiving passage and partially exposed beyond at least one of the first and second supporting surfaces to be located behind the nonelastic first mating portion along the mating direction, a second retention portion interferentially received in the base portion of the insulative housing, and a second tail portion extending from the second retention portion and beyond the base portion.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an exploded, perspective view of an electrical connector in accordance with the present invention;

FIG. 2 is a view similar to FIG. 1, but viewed from a different aspect;

FIG. 3 is a partially cross-sectional view of an insulative housing of the electrical connector;

FIG. 4 is a perspective view of a first conductive contact of the electrical connector;

FIG. 5 is an assembled, perspective view of FIG. 1;

FIG. 6 is a view similar to FIG. 5, but viewed from a different aspect;

FIG. 7 is a cross-section view taken along line 7-7 of FIG. 5; and

FIG. 8 is a cross-sectional view taken along line 8-8 of FIG. 5.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

Within the following description, a standard USB connector, plug, and signaling all refer to the USB architecture described within the Universal Serial Bus Specification, 2.0 Final Draft Revision, Copyright December, 2002, which is hereby incorporated by reference herein. USB is a cable bus that supports data exchange between a host and a wide range of simultaneously accessible peripherals. The bus allows peripherals to be attached, configured, used, and detached while the host and other peripherals are in operation. This is referred to as hot plug.

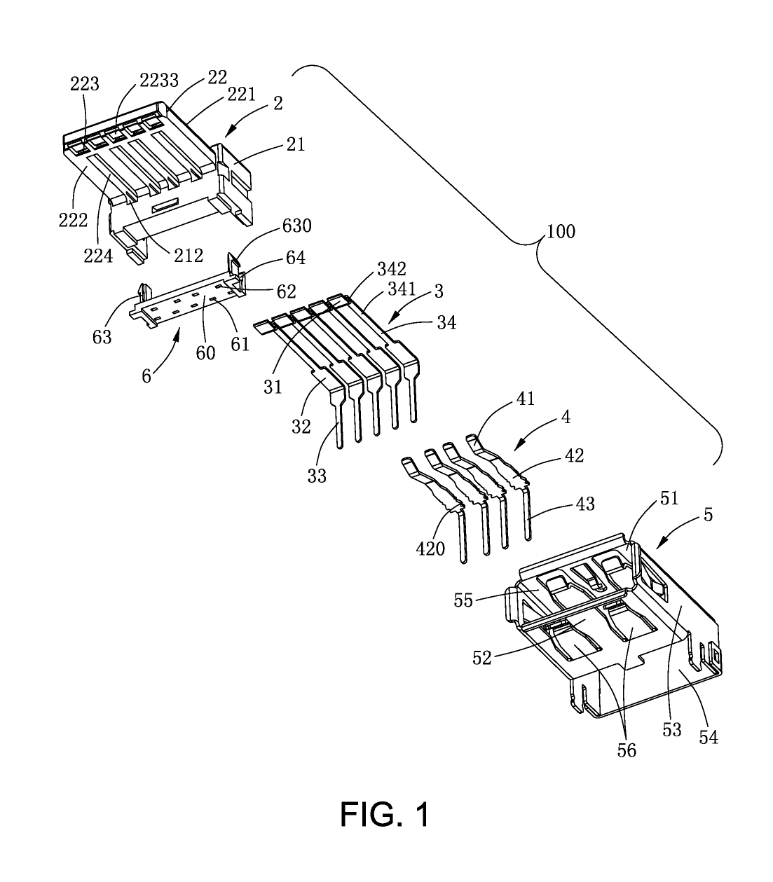

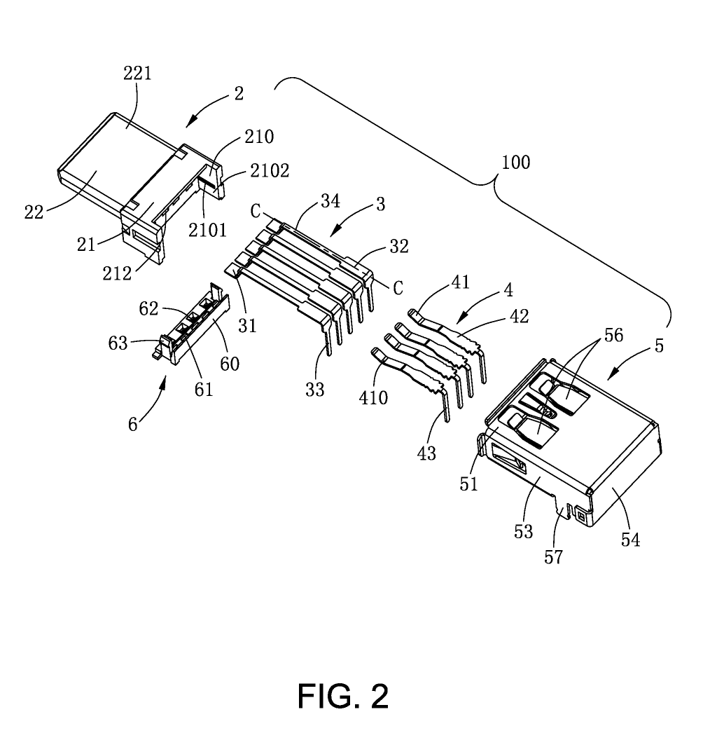

Referring to FIGS. 1-2, an electrical connector 100 according to a preferred embodiment of the present invention is disclosed. The electrical connector 100 comprises an insulative housing 2, a first set of contacts 3 and a second set of contacts 4 supported in the insulative housing 2, and a metal shell 5 enclosing the insulative housing 2 and the contacts 3, 4. In the preferred embodiment of the present invention, the electrical connector 100 fulfills the transmission standard of USB 3.0 and is compatible with interface of the A-type USB 2.0. Detail description of these elements and their relationship and other elements formed thereon will be detailed below.

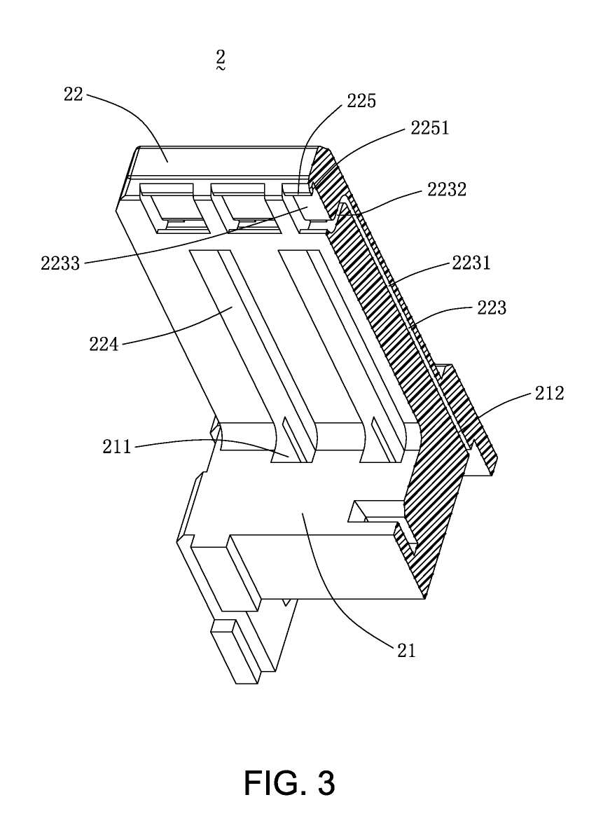

Referring to FIGS. 1-3, the insulative housing 2 comprises a rectangular base portion 21 and a tongue portion 22 extending forwardly from a middle of a front surface of the base portion 21. The base portion 21 and the tongue portion 22 of the insulative housing 2 are integrally injecting molded as a unit one piece. The base portion 21 defines a rectangular termination space 210 recessed forwardly from a rear surface thereof, a plurality of first contact-receiving passageways 211 arranged in an upper row, and a plurality of second contact-receiving passageways 212 arranged in a lower row. The termination space 210 is of U-shape and forms a pair of latch sections 2101 extending along front-to-back direction on a pair of lateral walls 2102 of the base portion 21.

The tongue portion 22 has an upper first supporting surface 221 and opposite lower second supporting surface 222. Four second contact-receiving passages 224 are recessed upward from the second supporting surface 222 to communicate with respectively second contact-receiving passageways 212. Five first contact-receiving passages 223 communicate with corresponding first contact-receiving passageways 211 and penetrate through the tongue portion 22 to communicate with the second supporting surface 222 finally. That means that each first contact-receiving passage 223 is of Z-shape and comprises a main section 2231 penetrating through the tongue portion 22 along front-to-back direction from the first contact-receiving passageway 211, a mating section 2233 recessed upward from the second supporting surface 222, and a connecting section 2232 extending downward from the main section 2231 (toward the second supporting surface 222) and connecting the mating section 2233 and the main section 2231. The tongue portion 22 forms five arc-shape protecting sections 225. Each protecting section 225 extends from a front edge of the tongue portion 22 and partially into the mating section 2233. Thus, a protecting slit 2251 is defined between the protecting section 225 and a bottom surface of the mating section 2233 to protect a front edge 310 of the first contact 3. The mating sections 2233 and the second contact-receiving passages 224 together occupy the second supporting surface 222 along a front-to-back direction, while the second contact-receiving passages 224 occupy majority of the second supporting surface 222.

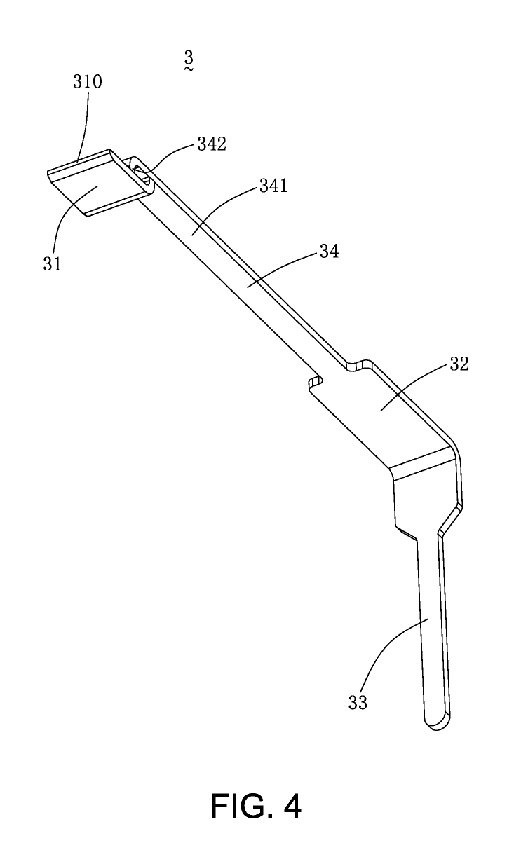

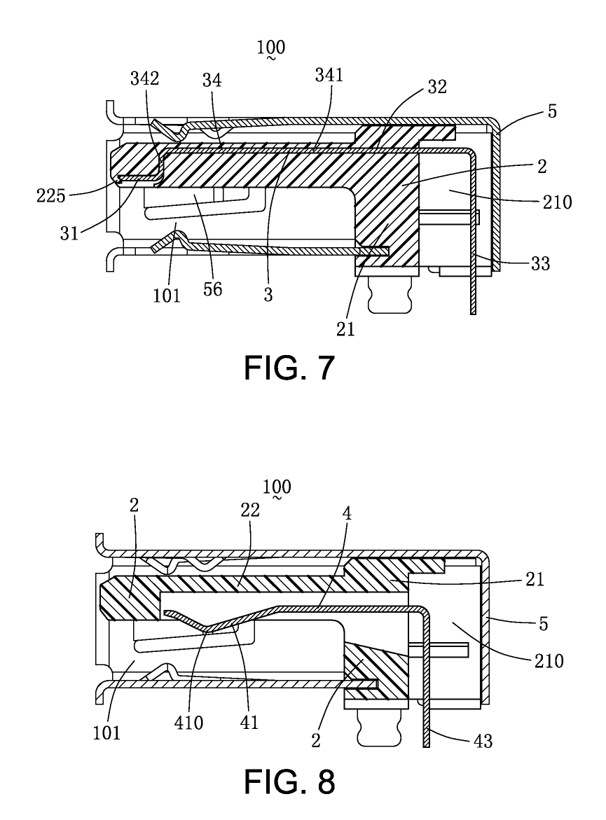

Referring to FIGS. 1-2 in conjunction with FIGS. 4 and 7, the first set of contacts 3 is insert-molded with the insulative housing 2. Each first contact 3 comprises a first retention portion 31 molded within the first contact-receiving passageway 211, a connecting portion 34 molded within rear part of the first contact-receiving passage 223, a first mating portion 31 received in front part of the first contact-receiving passage 223, and a first tail portion 33 bending downward from the first retention portion 32 to be exposed into the termination space 210. The connecting portion 34 is of L-shape to connect the first mating portion 31 and the first retention portion 32 which locate in different surfaces. In the preferred embodiment of the present invention, the first retention portion 32 and the first mating portion 31 are parallel to each other and with the same width as each other.

The connecting portion 34 has a width smaller than that of the first mating portion 31 and the first retention portion 32. The ratio between the width of the connecting portion 34 and the width of the first retention portion 32 and the first mating portion 31 can range from 1:2 to 1:4. In the preferred embodiment of the present invention, the ratio is 1:3. The narrower connecting portion 34 is capable of increasing the impedance of the first contact 3 to make the first contact 3 fulfill the high-speed, high-frequency signal transmission standard. The connecting portion 34 comprises a horizontal first connecting section 341 located in the same plane as that of the first retention portion 32 to be received in the main section 2231 of the first contact-receiving passage 223, and a vertical second connecting section 342 connecting the first connecting section 341 and the first mating portion 31 which is located in a lower plane to be received in the connecting section 2232. A plurality of barbs (not shown) can be disposed on lateral sides of the first mating portion 31 and the first retention portion 32 for increasing the retention force between the first contact 3 and the insulative housing 2.

The front edge 310 of the first mating portion 31 is received in the protecting slit 2251 and the first mating portion 31 is exposed in the mating section 2233 and located in a surface higher than the second supporting surface 222. The five first contacts 3 comprise two pairs of differential contacts for high-speed signal transmission, and a grounding contact located between the two pairs of differential contacts for suppressing cross-talk. One differential pair is used for receiving signals, and the other differential pair is used for transmitting signals. It should be mentioned that the first contact 3 defines a center-line C-C along a mating direction of the electrical connector 100 (FIG. 2), and the first contact 3 has a symmetrical structure relative to the center-line C-C including the connecting portion 34.

Please refer to FIGS. 1-2 and 8, the second set of contacts 4 are assembled to the insulative housing 2 along back-to-front direction. Each second contact 4 comprises a flat second retention portion 42 interferentially received in the second contact-receiving passageways 212, a second mating portion 41 extending forwardly from the second retention portion 42 and elastically curved upwardly, and a second tail portion 43 extending rearward from the second retention portion 42 then bending downwardly. The second retention portion 42 forms a plurality of barbs (interference sections) 420 on opposite lateral sides thereof for interferentially engaging with the second contact-receiving passageways 212. The second mating portion 41 is partially received in the second contact-receiving passages 224 with curved contacting section 410 located below the second supporting surface 222 for forming electrical connection with a complementary connector (not shown). The four second contacts 4 comply with USB 2.0 standard, and one is a power contact, two are a pair of positive and negative contacts, and one is a grounding contact in turn.

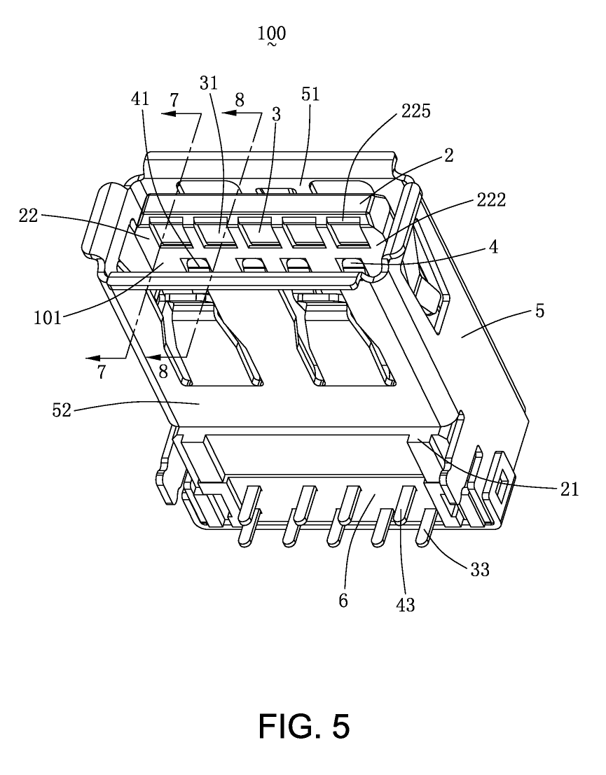

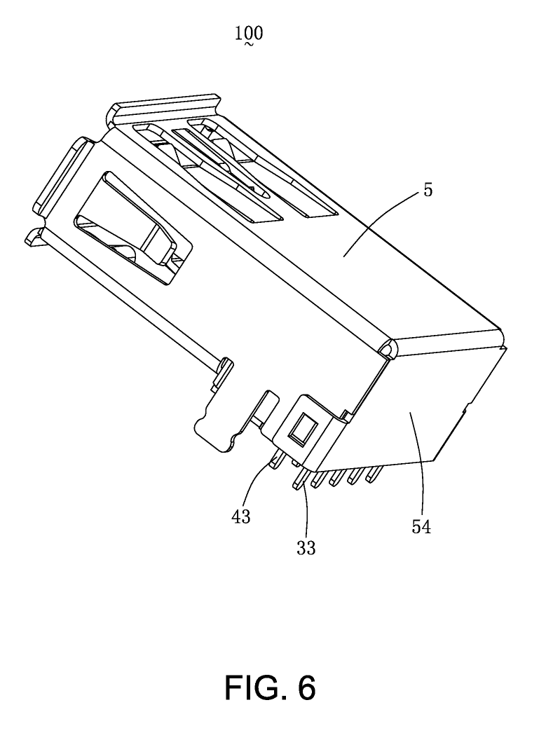

Please refer to FIGS. 1-2 in combination with FIGS. 5-6, the shell 5 is stamped from a metal sheet and comprises a rectangular receiving space 55 circumscribed by opposite upper and lower walls 51, 52, opposite left and right lateral walls 53 and a rear wall 54. The insulative housing 2 is received in the receiving space 55 of the shell 5 with the upper wall 51 forming a mating space 101 together with the second supporting surface 222 for receiving the complementary connector to form electrical connection with the first and second sets of contacts 3, 4. Except the rear wall 54, each wall of the shell 5 is formed with a plurality of elastic fingers 56 for elastically abutting against a metal shell of the complementary connector to form shielding protection. The shell 5 is assembled to the insulative housing 2 along the front-to-back direction to interferentially engage with the base portion 21 and the rear wall 54 being bent downwardly to seal the termination space 210. Each lateral wall 53 is formed with a board-lock 57 extending downwardly therefrom for locking with a printed circuit board to which the electrical connector 100 is mounted.

Referring to FIGS. 1-2 in conjunction with FIG. 5, the electrical connector 100 in accordance with the present invention also comprises a spacer 6 which is assembled to the insulative housing 2 along down-to-up direction to latch with the insulative housing 2 for aligning the tail portions 33, 43 of the first and second sets of contacts 3, 4. The spacer 6 comprises a main body 60 defining five first retaining holes 61 arranged in a rear row and four second retaining holes 62 arranged in a front row, a pair of latch sections 63 extending upwardly from opposite lateral sides of the main body 60, and a block portion 64 extending upwardly from a rear edge of the main body 60. When the spacer 6 is assembled to be received in the termination space 210 of the insulative housing 2, latches 630 formed at free ends of the latch sections 63 latch with the latch sections 2101 to secure the spacer 6. The tail portions 33, 43 of the contacts 3, 4 respectively protrude through the first and second retaining holes 61, 62 then electrically connect to the printed circuit board.

It is no need to utilize high-technology to manufacture the first and second sets of contacts 3, 4 and the insulative housing 2 of the present invention. Current molds can satisfy the manufacture needs. The non-elastic Z-shape first mating portions 31 of the first contacts 3 is of simple configuration and insert-molded with the insulative housing 2 to save time and improve efficiency. The narrower connecting portion 34 improves the high-frequency feature of the first contact 3 to improve high-frequency transmission function. In addition, the mating portions 31, 41 of the contacts 3, 4 all are located at the same side of the insulative housing 2 that is the second supporting surface 222. But, in an alternative embodiment, the mating portions 31, 41 can be arranged to be located at different sides of the insulative housing 2 that is the first and second supporting surfaces 221, 222.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

1. An electrical connector defining a mating direction, comprising:
an insulative housing comprising a rear base portion and a front tongue portion extending from the base portion, the tongue portion defining opposite first supporting surface and second supporting surface both parallel to the mating direction, and a plurality of front first contact-receiving passages to communicate with at least one of the first and second supporting surfaces, and a plurality of rear second contact-receiving passages to communicate with at least one of the first and second supporting surfaces;
a first set of contacts insert-molded with the insulative housing and comprising at least one pair of differential contacts for transmitting high-speed signals, each first contact comprising a nonelastic first mating portion received in corresponding first contact-receiving passage, a first retention portion interferentially received in the base portion of the insulative housing and located in a surface different from that of the first mating portion, a first tail portion extending from the first retention portion and extending beyond the base portion, and a connecting portion connecting the first mating portion and the first retention portion with a width narrower than that of the first mating portion and the first retention portion;
a second set of contacts assembled to the insulative housing along said mating direction, and each of the second set of contacts comprising an elastic second mating portion received in the rear second contact-receiving passage and partially exposed beyond at least one of the first and second supporting surfaces to be located behind the nonelastic first mating portion along the mating direction, a second retention portion interferentially received in the base portion of the insulative housing, and a second tail portion extending from the second retention portion and beyond the base portion;
wherein the first retention portion and the first mating portion are located in different first horizontal surface and second horizontal surface, and wherein the connecting portion is of L-shape to connect the first retention portion and the first mating portion;
wherein the connecting portion comprises a first connecting section located in the same plane as that of the first retention portion, and a vertical second connecting section connecting with the first connecting section and the first mating portion.

2. The electrical connector as claimed in claim 1, wherein the ratio between the width of the connecting portion and the width of the first retention portion is about 1:3.

3. The electrical connector as claimed in claim 2, wherein the first mating portion is parallel to the first retention portion and with the same width as that of the first retention portion.

4. The electrical connector as claimed in claim 1, wherein the first contact defines a center-line along said mating direction, and wherein the first contact is of symmetrical structure relative to the center-line.

5. The electrical connector as claimed in claim 1, wherein the first set of contacts comprises another pair of differential contacts and a grounding contact located between the two pairs of differential contacts, and wherein each first contact comprises a narrow connecting portion.

6-7. (canceled)

8. The electrical connector as claimed in claim 1, wherein the tongue portion forms a plurality of protecting sections at a front edge thereof to protect front edges of the first set of contacts.

9. The electrical connector as claimed in claim 8, wherein the front edge of the tongue portion and a bottom surface of the first contact-receiving passage form a protecting slit to receive the front edge of each first contact.

10. The electrical connector as claimed in claim 1, wherein the base portion of the insulative housing defines a plurality of first contact-receiving passageways communicating with the first contact-receiving passages to receive the first retention portions, and plurality of second contact-receiving passageways communicating with the second contact-receiving passages to receive the second contact-receiving passages to receive the second retention portions.

11. The electrical connector as claimed in claim 1, wherein the geometric profile of the tongue portion is substantially same as that of a standard type-A USB 2.0 plug.

12. The electrical connector as claimed in claim 1, wherein the second set of contacts is adapted for USB protocol and an arrangement of the second set of contacts is compatible to a standard USB receptacle, and wherein the pair of differential contacts is adapted for non-USB protocol.

13. The electrical connector as claimed in claim 1, further comprising a shell enclosing the insulative housing, and wherein a mating space is defined by the shell and the tongue portion of the insulative housing, and the first and second mating portions of the first and second set of contacts is exposed into the mating space.

14. The electrical connector as claimed in claim 1, further comprising a spacer assembled to the base portion of the insulative housing, and wherein the first and second tail portions of the first and second set of contacts is aligned by the spacer.

15. The electrical connector as claimed in claim 14, wherein the spacer defines at least a pair of first retaining holes with the first tail portions of the first set of contacts protruding therethrough, and a plurality of second retaining holes with the second tail portions of the second set of contacts protruding therethrough.

16. The electrical connector as claimed in claim 14, wherein the spacer forms a pair of latch sections at opposite lateral sides thereof to latch with the base portion of the insulative housing.

17. An electrical connector defining a mating direction, comprising:
an insulative housing comprising a rear base portion and a front tongue portion extending from the base portion, the tongue portion defining opposite first supporting surface and second supporting surface both parallel to the mating direction, and a plurality of front first contact-receiving passages to communicate with at least one of the first and second supporting surfaces, and a plurality of rear second contact-receiving passages to communicate with at least one of the first and second supporting surfaces;
a first set of contacts held in the insulative housing and comprising at least one pair of differential contacts for transmitting high-speed signals, each first contact comprising a nonelastic first mating portion received in corresponding first contact-receiving passage, a first retention portion interferentially received in the base portion of the insulative housing and located in a surface different from that of the first mating portion, a first tail portion extending from the first retention portion and extending beyond the base portion, and a connecting portion connecting the first mating portion and the first retention portion;
a second set of contacts held in the insulative housing, each of the second set of contacts comprising an elastic second mating portion received in the rear second contact-receiving passage and partially exposed beyond at least one of the first and second supporting surfaces to be located behind the nonelastic first mating portion along the mating direction, a second retention portion interferentially received in the base portion of the insulative housing, and a second tail portion extending from the second retention portion and beyond the base portion; and wherein
the ratio between the width of the connecting portion and the width of at least one of the first mating portion and the first retention portion ranges from 1:2 to 1:4;
wherein the first set of contacts is insert-molded with the insulative housing, and wherein the second set of contacts is mechanically assembled to the insulative housing along said mating direction; and
wherein each first contact defines a center-line, and wherein the first contact has a symmetrical structure relative to the center-line.

18. The electrical connector as claimed in claim 17, wherein the ratio between the width of the connecting portion and the width of at least one of the first mating portion and the first retention portion is 1:3.

19-20. (canceled)
